(19) United States
(12) Patent Application Publication
(10) Pub. No.: US 2024/0287830 A1
(43) Pub. Date: Aug. 29, 2024

(54) LIGHTED FABRIC PANEL

(71) Applicant: The Coleman Company, Inc., Wichita, KS (US)

(72) Inventors: Yiyun Culp, Wichita, KS (US); Robert Lawhon, Andover, KS (US); Isaiah Gross, Haven, KS (US)

(21) Appl. No.: 18/582,753

(22) Filed: Feb. 21, 2024

Related U.S. Application Data
(60) Provisional application No. 63/486,671, filed on Feb. 24, 2023.

(51) Int. Cl. E04H 15/10; F21S 4/24; F21S 9/03; F21V 15/01; F21V 33/00; F21Y 115/10

(52) U.S. Cl. CPC E04H 15/10; F21S 4/24; F21S 9/03; F21V 15/01; F21V 33/006; F21Y 2115/10

(57) ABSTRACT

The present disclosure relates to a lighting assembly for use with a tent or other portable shelter. The lighting assembly can include a lighting strip that is coupled to the fabric panel of the tent or shelter via a transparent or semi-transparent sleeve.

### CROSS-REFERENCE TO RELATED APPLICATIONS

The present application claims priority to U.S. Provisional Patent Application No. 63/486,671, filed Feb. 24, 2023, the entire contents of which are hereby incorporated by reference.

### FIELD OF INVENTION

The present disclosure relates to lighting systems for tents or portable shelters.

### BACKGROUND OF THE INVENTION

Portable shelters and tents are used for numerous activities including camping, sporting events, picnics, beach-going, fairs, and the like. Often, such structures provide shade from the sun and protection from weather elements. Shelters and tents typically include a fabric exterior and a metal frame.

Most tents and shelters come with minimal or no lighting and rely on external sources of light to provide illumination inside or outside of the shelter. Tents and shelters that do include lighting systems typically integrate those systems into the tent poles or shelter frames, which makes it difficult for consumers to upgrade non-lighted products to include lights or to repair or replace existing lighted products. The present disclosure seeks to address these disadvantages.

### SUMMARY OF INVENTION

The present invention overcomes many of the shortcomings and limitations of the prior art devices discussed above. Thus, the present disclosure relates generally to a lighting system for use with a tent or portable shelter. The lighting system can be coupled to a fabric panel of the tent or shelter to provide light to an interior or exterior of the tent or canopy and can thus be used for entertainment, ambient, or safety purposes. The lighting system can generally comprise a lighting strip (for example, an LED lighting strip) placed within a transparent or semi-transparent sleeve. The sleeve can then be coupled to a transitional fabric piece that can be seam-taped to allow the sleeve to be waterproof. The transitional fabric piece can, in turn, be coupled to the fabric panel of the tent or shelter.

These and other aspects and advantages of the present invention will become apparent to those skilled in the art after considering the following detailed description in connection with the accompanying drawings.

### BRIEF DESCRIPTION OF DRAWINGS

FIG. 1 is a perspective view of a tent incorporating the lighting system of the present disclosure.

FIG. 2 is an enlarged top plan view of a segment of the lighting system of the present disclosure.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

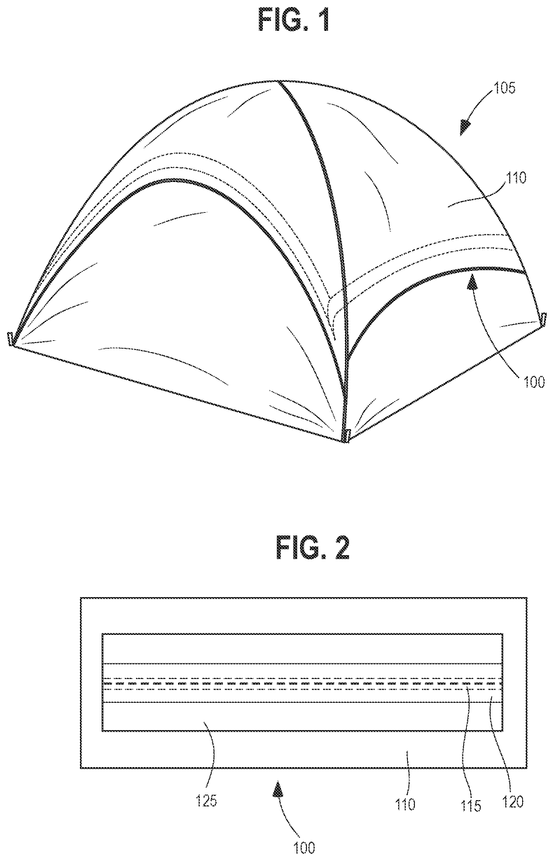

Referring now to FIG. 1, the present disclosure relates generally to a lighting assembly 100 for use with a shelter, such as a tent 105. The lighting assembly 100 can be integrated into a shelter canopy in the same way described herein. The lighting assembly 100 may also be integrated into any other structure having fabric panels, including lighted screen houses, lighted beach shades, lighted tarps, and the like. The lighting assembly 100 can be integrated into any fabric panel 110 of the tent or shelter, such as the rainfly, the shade, the canopy, or any other appropriate location. In this way, fabric panels with integrated lighting can be purchased independently and used with already-owned tent poles or shelter structures to upgrade the tent or canopy to a lighted version or for repair or replacement purposes. The lighting assembly 100 can be present on the interior or exterior of the tent or canopy.

The lighting assembly 100 can be coupled to the fabric panel 110 of the tent or canopy as best shown in FIG. 2. The lighting assembly 100 can include a flexible lighting strip 115. The lighting strip 115 can be, for example, an LED lighting strip. The lighting strip 115 can be placed inside a sleeve 120. The sleeve 120 can be, for example, a transparent material or a semi-transparent material to allow for diffusion of light. The sleeve 120 can be coupled to a transitional fabric panel 125 via any appropriate method, such as by sewing, adhesive, or any other appropriate joining method. The transitional fabric panel 125 can then be coupled to the fabric panel 110 of the tent or canopy. The transitional fabric panel 125 can be seam-taped at the join location with the sleeve 120 to allow for the sleeve to be waterproof, which is preferred when the lighting strip 115 is not itself waterproof. Other waterproofing methods of the sleeve 120 are also foreseen. In embodiments where the lighting strip 115 may already be waterproof, the sleeve 120 can be directly coupled to the fabric panel 110 without the need for the transitional fabric panel 125.

The lighting strip 115 can be powered through any means known in the art. For example, it can be powered through a standard wall outlet, a portable battery pack, a solar panel, or any other appropriate means. The strip 115 can be controlled via a built-in on/off switch, a remote, a phone app, or other means. The strip 115 can be equipped with a variety of lighting functions, including different light intensities and brightnesses, colors, flashing frequencies or patterns, and the like. Some embodiments may include the ability of the strip 115 to flash or change colors in response to music. Thus, the lighting strip 115 can enhance entertainment but may also provide ambient light or light for safety purposes.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

What is claimed is:

1. A lighted shelter comprising:
a shelter frame;
a fabric panel coupled to the shelter frame;
a sleeve coupled to the fabric panel; and
a lighting strip held within the sleeve.

2. The lighted shelter of claim 1, wherein the sleeve is one of transparent or semi-transparent.

3. The lighted shelter of claim 1, wherein light emitted from the lighting strip is present on an interior and an exterior of the lighted shelter.

4. The lighted shelter of claim 1, wherein the lighting strip is flexible.

5. The lighted shelter of claim 1, wherein the fabric panel is seam-taped at a join location with the sleeve.

6. The lighted shelter of claim 1, wherein the sleeve is waterproof.

7. The lighted shelter of claim 1, wherein the lighting strip is powered by at least one of a wall outlet, battery, and solar panel, and wherein the lighting strip is controlled via at least one of an on/off switch, a remote, and a phone application.

8. The lighted shelter of claim 1, wherein the lighting strip comprises at least one of the following adjustable functions: light intensity; light brightness; color; and flash pattern.

9. A lighted shelter comprising:
a shelter frame;
a fabric panel coupled to the shelter frame; and
a lighting strip coupled to the fabric panel.

10. The lighted shelter of claim 9, wherein the lighting strip is waterproof.

11. The lighted shelter of claim 9, further comprising a sleeve coupled to the fabric panel, and wherein the lighting strip is held within the sleeve.

12. The lighted shelter of claim 11, wherein the sleeve is one of transparent or semi transparent.

13. The lighted shelter of claim 9, light emitted from the lighting strip is present on an interior and an exterior of the lighted shelter.

14. The lighted shelter of claim 9, wherein the lighting strip is flexible.

15. The lighted shelter of claim 9, wherein the lighting strip is powered by at least one of a wall outlet, battery, and solar panel, and wherein the lighting strip is controlled via at least one of an on/off switch, a remote, and a phone application.

16. The lighted shelter of claim 9, wherein the lighting strip comprises at least one of the following adjustable functions: light intensity; light brightness; color; and flash pattern.

17. A lighted shelter comprising:
a shelter frame;
a fabric panel coupled to the shelter frame;
a sleeve coupled to the fabric panel; and
a lighting strip held within the sleeve;
wherein the sleeve is one of transparent or semi transparent.

18. The lighted shelter of claim 17, wherein light emitted from the lighting strip is present on an interior and an exterior of the lighted shelter.

19. The lighted shelter of claim 17, wherein the lighting strip is powered by at least one of a wall outlet, battery, and solar panel, and wherein the lighting strip is controlled via at least one of an on/off switch, a remote, and a phone application.

20. The lighted shelter of claim 17, wherein the lighting strip comprises at least one of the following adjustable functions: light intensity; light brightness; color; and flash pattern.
